(19) United States
(12) Patent Application Publication
(10) Pub. No.: US 2025/0092703 A1
(43) Pub. Date: Mar. 20, 2025

(54) FRAME POOL AND SUPPORT ASSEMBLY THEREFOR

(71) Applicant: BESTWAY INFLATABLES & MATERIAL CORP., Shanghai (CN)

(72) Inventor: Xianglin ZENG, Shanghai (CN)

(21) Appl. No.: 18/742,678

(22) Filed: Jun. 13, 2024

(30) Foreign Application Priority Data
Sep. 20, 2023 (CN) 202322570945.4

(51) Int. Cl. E04H 4/00

(52) U.S. Cl. CPC E04H 4/0056

(57) ABSTRACT

The present embodiments disclose a support assembly, comprising: a side-section horizontal support member, one or more sleeve insertion apertures being provided in a bottom surface of an outer wall of the side horizontal support member; a frame support assembly having at least insertion end; assembly sleeves arranged in the sleeve insertion apertures, the assembly sleeves each comprising: an assembly sleeve body comprising a sleeve side wall and an insertion channel, the insertion channel accommodating the insertion end; and one or more support strut retainers arranged on the first side wall, each of the one or more support strut retainers being configured to retain the insertion ends in the assembly sleeve. The embodiments provide enhanced rust and/or corrosion prevention effect along with convenient and quick assembly. Present embodiments further provide a frame pool kit comprising a pool liner and a pool frame that includes the support assembly.

### CROSS REFERENCE TO RELATED APPLICATIONS

This application claims priority from Chinese Application CN 202322570945.4, filed Sep. 20, 2023 in China, the disclosure of which is incorporated herein by reference in its entirety for all purposes.

### FIELD AND BACKGROUND

### Field

The present embodiments herein relate to the technical field of above-ground pools, and in particular to a support assembly and a frame pool.

### Background

An above-ground frame pool is an outdoor leisure product for people. Frame pools currently on the market support pool liners by means of horizontal support members such that the pool liners accommodate water, and the horizontal support members are supported on the ground by means of above-ground support members.

At present, the connection between the above-ground support members and the horizontal support members is implemented mainly by forming through-holes at end portions of the above-ground support members, forming mounting holes at the bottoms of the horizontal support members, and using connecting members (such as V-shaped spring pins or other connecting components) to secure the end portions of the above-ground support members in the mounting holes.

In the above solution, water is likely to enter the insides of the above-ground support members, causing a rust and/or corrosion in the pool frame and the need to utilize the referenced connecting members increases assembly difficulty.

### SUMMARY OF THE EMBODIMENTS

The following technical disclosure is exemplary and explanatory only and is not necessarily restrictive of the invention as claimed.

An objective of the present embodiments is to solve the current problem that water or other effluents are likely to enter inside areas of pool frame elements, such as frame support assembly elements and/or side member elements. Water and/or other effluents inside such pool frame elements increase the accumulation of rust and/or corrosion inside of such elements, shortening their service life and compromising user safety. The present embodiments provide a support assembly, a frame pool and frame pool kit, which provide advantages of inhibiting rust/corrosion formation in internal frame elements, while offering convenience and ease of assembly.

In order to solve the above technical problem, an embodiment provides a support assembly, comprising:

a side-section horizontal support member, one or more sleeve insertion apertures defined within a bottom side of an outer wall of the side-section horizontal support member; a frame support assembly having one or more insertion ends; one or more assembly sleeves respectively installed in the at least one sleeve insertion apertures, the one or more assembly sleeves each comprising: an assembly sleeve body comprising a sleeve side wall and an insertion channel defined within the assembly sleeve body, the insertion channel configured to accommodate one of the one or more insertion ends; and one or more support strut retainers arranged on the sleeve side wall, each of the one or more support strut retainers being configured to accept and retain one of the one or more insertion ends in the one or more assembly sleeve.

In various embodiments, the assembly sleeve body comprises: one or more sleeve retention lugs arranged on an outer surface of the sleeve side wall; and a flange extending along the outer surface of the sleeve side wall toward the outside of the insertion channel, the flange being spaced from the one or more sleeve retention lugs to define a sleeve retention channel.

In various embodiments, the outer wall of the side-section horizontal support member is formed into a shape corresponding to the sleeve insertion aperture toward the inside of the side-section horizontal support member to form a sleeve retention lip, and the sleeve retention lip is arranged in the sleeve retention channel to retain the assembly sleeve body in the sleeve insertion aperture.

In various embodiments, the frame support assembly may further comprise a retention opening that is disposed in a side wall of the insertion end; and each of the one or more support strut retainers is arranged in a respective slot defined within the sleeve side wall of one or more the assembly sleeves, each of the one or more support strut retainers further comprising: a flexible arm including a hinge end and a distal end, the hinge end connected to an edge of the slot abutting the support strut retainer; and a protrusion defined within an interior side of the flexible arm at the distal end and configured to engage within the retention opening with a snap fit to retain a vertical support strut of the frame support assembly within the assembly sleeve.

In various embodiments, the support strut retainer comprises a plurality of protruding ribs arranged on an inner surface of the sleeve side wall at intervals in a circumferential direction of the assembly sleeve body.

According to another specific implementation, a cross section of the assembly sleeve body is circular or oval.

According to another specific implementation, the frame support assembly is U-shaped.

In various embodiments, regarding the support assembly, an outer diameter of the insertion end is less than an outer diameter of a remaining portion of the frame support assembly.

There is also provided, in certain embodiments, a frame pool comprising: a liner; and a frame assembly for supporting the liner, the frame assembly comprising: two arcuate sections symmetrically arranged, each arcuate section comprising a plurality of arc-section horizontal support members, a plurality of vertical support members and a plurality of T-joints, every two adjacent arc-section horizontal support members connected to one of the vertical support members through one of the T-joints; and two straight sections respectively arranged between the two arcuate sections, each straight section including at least one support assembly, each at least one support assembly including a side-section horizontal support member coupled to a frame support assembly through at least one assembly sleeve; wherein each straight section is respectively arranged between the two arcuate sections; each side-section horizontal support member is coupled at each end thereof to an end of one of the two arcuate sections at interceding T-joints, each interceding T-joint further coupled to a vertical support member, whereby the coupled arcuate sections and straight sections form a closed frame to support the liner.

In various embodiments, each of the side-section horizontal support members has defined in a bottom side therein at least one sleeve insertion aperture; and each of the assembly sleeves is respectively installed in a respective sleeve insertion aperture, the assembly sleeves each comprising: an assembly sleeve body comprising a sleeve side wall and an insertion channel defined within the assembly sleeve body, the insertion channel configured to accommodate an insertion end of the frame support assembly of one of the at least one support assembly; and one or more support strut retainers arranged on the sleeve side wall, each of the one or more support strut retainers being configured to accept and retain the insertion end in the assembly sleeve.

According to another specific implementation, an outer wall of each side-section horizontal support member is formed into a shape corresponding to the sleeve insertion apertures toward the inside of each of the side-section horizontal support members to form a sleeve retention lip, and the sleeve retention lip is arranged in each corresponding sleeve retention channel to retain the respective assembly sleeve body when inserted into the respective sleeve insertion aperture.

According to another specific implementation, the frame support assembly comprises a retention opening is disposed in a side wall of the insertion end; and each of the one or more support strut retainers is arranged in a respective slot defined within the sleeve side wall of the assembly sleeve, each of the one or more support strut retainers further comprising: a flexible arm including a hinge end and a distal end, the hinge end being connected to an edge of the slot abutting the support strut retainer; and a protrusion defined within an interior side of the flexible arm at the distal end and configured to engage within the retention opening with a snap fit to retain a vertical support strut of the frame support assembly within the assembly sleeve.

According to another specific implementation, the support strut retainer comprises a plurality of protruding ribs arranged on an inner surface of the sleeve side wall at intervals in a circumferential direction of the assembly sleeve body, and in another implementation, the frame support assembly is U-shaped.

According to another specific implementation, the frame pool further comprises: a plurality of band guides respectively affixed to the liner between pairs of the vertical support members of the frame assembly; and a reinforcing band that passes through the plurality of band guides and over the vertical support members and is tightened to secure and retain a position of each of the vertical support members and provide support for the liner.

There is also provided, in various embodiments, a frame pool kit comprising: a pool liner; and a support assembly, comprising: a side-section horizontal support member, one or more sleeve insertion apertures defined within a bottom side of an outer wall of the side-section horizontal support member; a frame support assembly having one or more insertion ends; a plurality of assembly sleeves configured to be respectively installed in the sleeve insertion apertures, the assembly sleeves each comprising: an assembly sleeve body comprising a sleeve side wall and an insertion channel defined within the assembly sleeve body, the insertion channel configured to accommodate the insertion end; and one or more support strut retainers arranged on the sleeve side wall, each of the one or more support strut retainers being configured to accept and retain the insertion end in the assembly sleeve.

According to another specific implementation, the assembly sleeve body comprises: one or more sleeve retention lugs arranged on an outer surface of the sleeve side wall; and a flange extending along the outer surface of the sleeve side wall toward the outside of the insertion channel, the flange being spaced from the one or more sleeve retention lugs to define a sleeve retention channel.

According to another specific implementation, the outer wall of the side-section horizontal support member is formed into a shape corresponding to the sleeve insertion aperture toward the inside of the side-section horizontal support member to form a sleeve retention lip, and the sleeve retention lip is configured to be arranged in the sleeve retention channel to retain the assembly sleeve body in the sleeve insertion aperture when the assembly sleeve body is inserted therein.

In another specific implementation, the frame support assembly comprises a retention opening disposed in a side wall of the insertion end; and each of the one or more support strut retainers is arranged in a respective slot defined within the sleeve side wall of the assembly sleeve, each of the one or more support strut retainers further comprising: a flexible arm including a hinge end and a distal end, the hinge end connected to an edge of the slot abutting the support strut retainer; and a protrusion defined within an interior side of the flexible arm at the distal end and configured to engage within the retention opening with a snap fit so as to retain a vertical support strut of the frame support assembly within the assembly sleeve.

In yet another implementation, the support strut retainer comprises a plurality of protruding ribs arranged on an inner surface of the sleeve side wall at intervals in a circumferential direction of the assembly sleeve body.

### BRIEF DESCRIPTION OF THE DRAWINGS

A more complete understanding of the present embodiments may be derived by referring to the detailed description and claims when considered in connection with the following illustrative figures.

FIG. 1 shows a perspective view of a frame pool according to an example embodiment;

FIG. 2 shows a perspective view of a support assembly according to an example embodiment;

FIG. 3 shows a partial enlarged view of part A in FIG. 2;

FIG. 4 shows an exploded view of a support assembly according to an example embodiment;

FIG. 5 shows a perspective view of a mounting sleeve of a support assembly according to an example embodiment;

FIG. 6 shows a cross-sectional view of a connection of a first horizontal support member, an above-ground support member and a mounting sleeve of a support assembly according to example embodiments;

FIG. 7 shows a perspective view of a mounting sleeve of a support assembly according to additional example embodiments;

FIG. 8 shows a cross-sectional view of a connection of a first horizontal support member, an above-ground support member and a mounting sleeve of a support assembly according to another example embodiment; and

FIG. 9 shows an exploded view of a support assembly according to another example embodiment.

### DETAILED DESCRIPTION

Implementations of the present embodiments are illustrated below by way of specific embodiments, and those skilled in the art would have readily understood other advantages and effects of the present embodiments from the content disclosed in the description. Although the description of the various embodiments will be introduced in conjunction with preferred embodiments, it does not mean that features of the present embodiments are limited to the described or illustrated implementations. On the contrary, an objective of introducing the various embodiments in conjunction with the described implementations is to encompass other options or modifications that may be extended on the basis of the claims of the present application. The following description contains numerous specific details in order to provide deep understanding of the present application. The present embodiments may also be implemented without these details. In addition, in order to avoid confusing or obscuring key points of the various embodiments, some specific details will be omitted in the description. It should be noted that the embodiments and the features thereof in the present application can be combined with each other without conflicts.

It should be noted that in the description, like reference signs and letters denote like items in the following drawings. Therefore, once an item is defined in one of the drawings, it is not necessary to further define and explain the item in the subsequent drawings.

In the description of the present embodiments, it should be noted that the orientation or position relationships indicated by the terms such as “upper”, “lower”, “inner” and “bottom” are based on the orientation or position relationships shown in the drawings or the orientation or position relationships in which a product of the present utility model is customarily placed during use, and are only intended to facilitate description of the present embodiments and simplify the description, rather than indicating or implying that the apparatus or element indicated must have a specific orientation or be configured and operated in the specific orientation, and therefore cannot be construed as limiting the present embodiments.

The terms “first”, “second”, etc. are only intended to distinguish the description, and should not be construed as indicating or implying the relative importance.

In the description of the various embodiments, it should also be noted that the terms “arrange”, “connected”, and “connection” should be understood in a broad sense, unless otherwise explicitly specified and limited. For example, a connection can be a secured connection, a detachable connection, or an integral connection; or may be a mechanical connection or an electrical connection; and can be directly connected, or indirectly connected by means of an intermediate medium, or communication between interiors of two elements. For those of ordinary skill in the art, the specific meaning of the terms mentioned above in the embodiments should be understood in specific cases.

In order to make objectives, technical solutions and advantages of the present embodiments clearer, the implementations of the present embodiments will be further described in detail below in conjunction with the drawings.

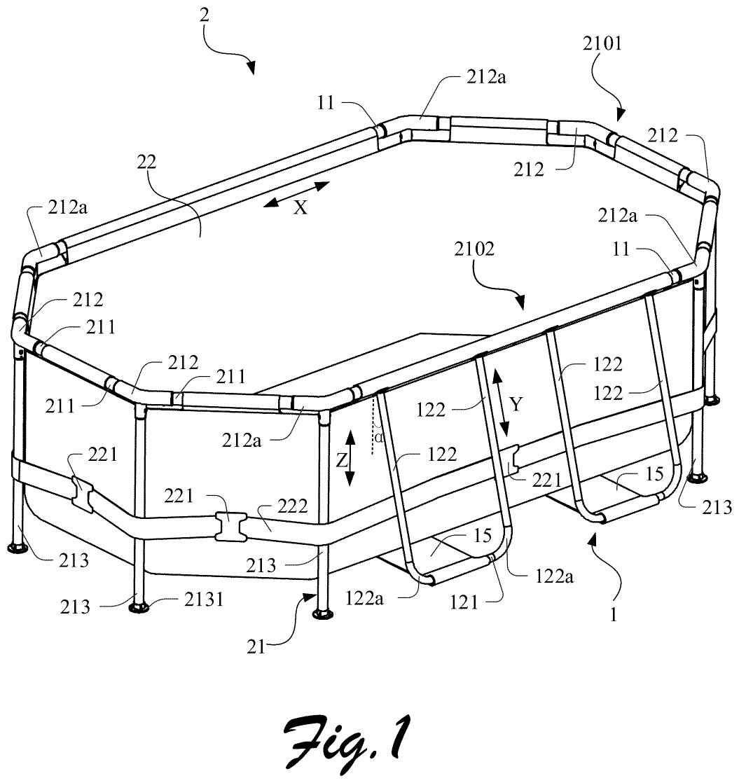

An embodiment of the present application provides a support assembly 1. Referring to FIG. 1, the support assembly 1 is a part of a pool frame 21 of a frame pool 2, the support assembly 1 providing support for the pool frame 21 on the ground. As explained in more detail below, the support assembly 1 provided by various embodiments herein provides advantages of inhibiting rust formation in internal frame elements, while offering convenience and ease of assembly of the frame pool 2.

FIG. 1 illustrates an embodiment of a frame pool 2, comprising: a pool frame 21 and a pool liner 22 (in various embodiments herein, the term “pool liner” may also be more generally referred to as a “liner”).

More specifically, the pool frame 21 supports the pool liner 22 on the ground or other horizontal surface to form the frame pool 2, so as to contain water or other effluent in an internal water storage space enclosed by the pool liner 22.

As an exemplary embodiment, the pool frame 21 comprises a plurality of arc-section horizontal support members 211, a plurality of T-joints 212, a plurality of vertical support members 213 and a plurality of support assemblies 1. Viewed from the top, the pool frame 21 of an embodiment of the present application is of a substantially oval structure. The pool frame 21 of the oval structure has arcuate sections 2101 and straight sections 2102.

Every two adjacent arc-section horizontal support members 211 are connected to one vertical support member 213 through one T-joint 212. With such a connection method, a plurality of arc-section horizontal support members 211 and the vertical support members 213 are connected (for example, sequentially) to form the arcuate sections 2101 of the oval structure. Correspondingly, the plurality of support assemblies 1 are connected (for example, sequentially) in a horizontal direction X to support the straight sections 2102 of the oval structure. In one aspect, the straight sections 2102 may be connected to the arcuate sections 2101 through interceding T-joints 212a (each of which interceding T-joints 212a is also coupled to a vertical support member 213) to complete the upper portion of the pool frame 21.

In the above-mentioned frame pool 2, the frame pool 2 is supported on the ground (or other horizontal surface) by the vertical support members 213 and the support assemblies 1, wherein the support assemblies 1 reduce/inhibit rusting within the pool frame 21, thus lengthening service life of the pool frame 21 and enhancing safe use of the frame pool 2.

In another possible implementation, the pool frame 21 comprises a plurality of support assemblies 1, the plurality of support assemblies 1 being connected (such as in a sequential manner) to form an annular frame. The shape of the pool frame 21 is not specifically limited to the embodiments illustrated or described herein. Viewed from the top, the pool frame 21 may be configured to have a rectangular shape (not shown, four sides of a structure of a rectangular pool frame are sequentially connected by the plurality of support assemblies 1), an oval shape, or other shapes.

In a possible implementation, a bottom end of the vertical support member 213 in a vertical direction Z is connected to a support base 2131, and the support base 2131 is configured to increase the contact area between the vertical support member 213 and the ground/horizontal supporting surface. This acts to more evenly distribute a load from the frame pool 2 to the ground/horizontal supporting surface to improve the overall stability of the pool frame 21 and accordingly, improve stability of the frame pool 2 filled with water.

In an embodiment, continuing to refer to FIG. 1, an outer surface of the pool liner 22 is provided with a band guide 221 and a reinforcing band 222, and the band guide 221 is connected to the outer surface of the pool liner 22. More specifically, each band guide 221 is arranged on the outer surface of the pool liner 22 between two adjacent vertical support members 213, a upper end and a lower end of each band guide 221 are connected to the outer surface of the pool liner 22 respectively, and the reinforcing band 222 passes through the band guides 221, and is arranged and tightened to pass around the frame pool 2 on outer surfaces of the vertical support members 213 to secure the vertical support members 213 between the pool liner 22 and the reinforcing band 222. In this way, the vertical support members 213 can abut and lean against the outer surface of the pool liner 22, thereby improving a retained shape of the pool liner 22 and preventing the vertical support members 213 from deflecting outwardly from the frame pool 2.

In some possible implementations, the reinforcing band 222 is arranged on the frame pool 2 at a height approximately equal to ⅓ of a height of the frame pool 2, so that a lower portion of the frame pool 2 can be effectively reinforced, and accordingly, such a reinforced lower portion of the pool liner 22 of the frame pool 2 provides a greater load-bearing capacity.

An embodiment of a structure of the support assembly 1 will be described below in detail with reference to the accompanying drawings.

### Embodiment I

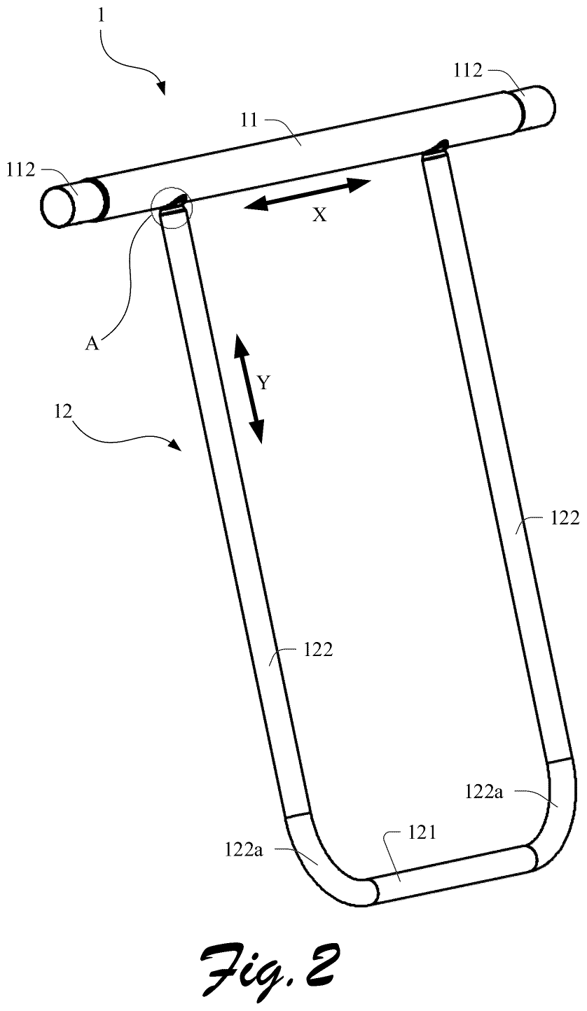

Referring to FIGS. 2 to 6, a support assembly 1 according to an embodiment comprises: a side-section horizontal support member 11, a frame support assembly 12 and assembly sleeves 13a. The frame support assembly 12 and the side-section horizontal support member 11 are connected through the interposed assembly sleeves 13a. It should be noted that the above-mentioned vertical support member 213 and the T-joint 212 may also be connected through an interposed assembly sleeve 13a, and a connection may be accomplished in a similar manner as embodiments set forth herein in more detail below.

In an exemplary embodiment, a side-section horizontal support member 11 extends in a horizontal direction X, and two sleeve insertion apertures 110 are defined within a bottom side 113 of an outer wall of the side-section horizontal support member 11. In this embodiment, two assembly sleeves 13a are provided that correspond to the number of the sleeve insertion apertures 110 on a one-to-one basis, and each assembly sleeve 13a is detachably inserted and retained in one sleeve insertion aperture 110.

As may be seen in FIG. 1, and as described in accordance with other embodiments, there may be multiple support assemblies 1 installed within any one side-section horizontal support member 11, (for instance, two support assemblies 1 within each side-section horizontal support member 11 on respective sides of the frame pool 2). More particularly, embodiments of the present application do not specifically limit the number of the sleeve insertion apertures 110. In various embodiments, the number of the sleeve insertion apertures 110 may also be one, three or four, and correspondingly, the number of the assembly sleeves 13a is the same as the number of the sleeve insertion apertures 110, such that one of each assembly sleeve 13a is detachably arranged in one of each sleeve insertion aperture 110.

In an embodiment, in the horizontal direction X, two ends of the side-section horizontal support member 11 are respectively provided with a connecting segment 112, and the connecting segment 112 is configured to connect the side-section horizontal support member 11 to one T-joint 212a or another side-section horizontal support member 11. In one embodiment, the connecting segment 112 is configured to slidably engage into a friction-fit to an internal opening within the T-joints 212a. Alternatively, V-shaped spring pins or other connecting components may be utilized to secure the connecting segments 112 within the T-joints 212a. Similar approaches may be used to secure the arcuate sections 2101 to respectively coupled T-joints 212, 212a.

Generally, an embodiment of the frame support assembly 12 has one or more insertion ends 1221 and a support portion (comprising at least a bottom support strut 121). The support portion is configured to provide support by transferring load from the pool frame 21 to the ground or any other desired supporting surface. Each insertion end 1221 is detachably inserted and retained in one assembly sleeve 13a as set forth in more detail below.

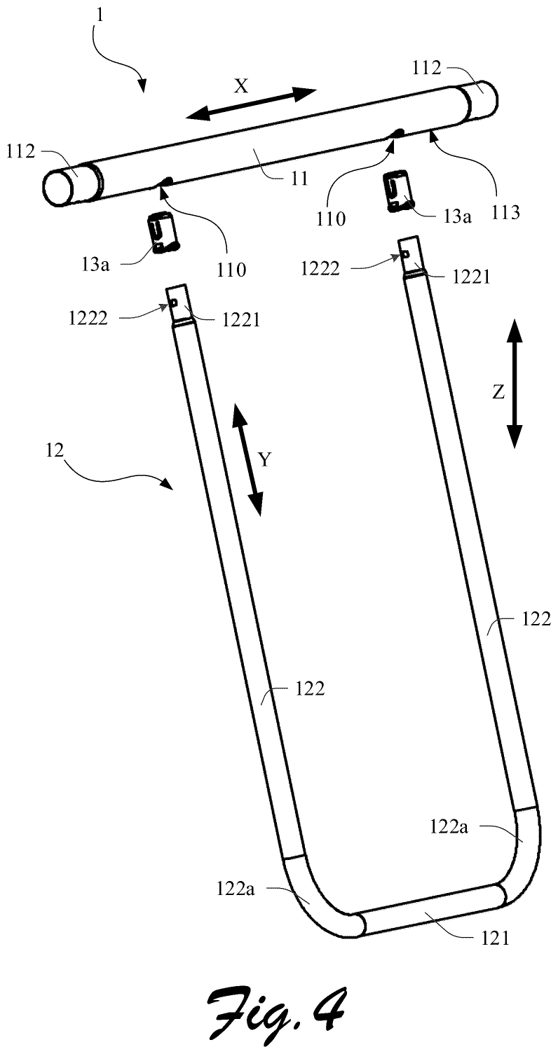

More particularly, referring to FIGS. 2 and 4, the frame support assembly 12 provides an inclined support member which comprises one bottom support strut 121 (i.e. the support portion) and two vertical support struts 122. One end of each vertical support strut 122 of the two vertical support struts 122 is connected to the bottom support strut 121 through a strut elbow 122a, and the other end comprises the insertion end 1221 (i.e. an end away from the bottom support strut 121), or put another way, each inclined support member is provided with two insertion ends 1221. Each insertion end 1221 may be swaged to a reduced outer diameter compared to an outer diameter of its corresponding vertical support strut 122. Two vertical support struts 122 coupled to one bottom support strut 121 through strut elbows 122a at respective ends of the bottom support strut 121 form a “U” shape, wherein the bottom support strut 121 is configured to provide support on the ground or other horizontal supporting surface, and the insertion ends 1221 are arranged in the assembly sleeves 13a.

Correspondingly, in an embodiment of the present application, a side-section horizontal support member 11 is provided with two sleeve insertion apertures 110, and one assembly sleeve 13a is installed in each of the two sleeve insertion apertures 110. Further, each assembly sleeve 13a is configured to accommodate insertion of one insertion end 1221 through a sleeve opening 1311 into an insertion channel 1312 defined within the assembly sleeve 13a.

In another possible implementation, two vertical support struts 122 and one bottom support strut 121 are of an integrally formed structure which is in a “U” shape and supports the side-section horizontal support member 11.

Referring to FIG. 1, when an inclined frame support assembly 12 is supported on the ground or other horizontal supporting surface, the two vertical support struts 122 of the frame support assembly 12 are arranged at an angle relative to a vertical direction Z, and more particularly, an included angle between each of the two vertical support struts 122 and the vertical direction Z is represented by α. The included angle α is not specifically limited in the embodiment of the present application and can be adjusted according to an actual size of the frame pool 2 and a desired amount of horizontal stability imparted to the frame support assembly 12. A retaining sleeve 15 may extend around at least part of a bottom support strut 121 of the frame support assembly 12 and may pass underneath the pool liner 22 and pass around a bottom support strut 121 of a frame support assembly 12 on an opposite side of the frame pool 2 (not shown). Alternatively, an end of the retaining sleeve 15 opposite the bottom support strut 121 wrapping end may be attached to a bottom surface of the pool liner 22. In part, the retaining sleeve 15 may provide additional stabilization of the frame support assembly 12 and may prevent the frame support assembly 12 from rotating in an outward direction from the frame pool 2, which would undesirably increase the angle α and reduce stability of the pool frame 21.

The specific structure of the frame support assembly 12 is not limited to the above-mentioned inclined vertical support struts 122. For example, the frame support assembly 12 may also include a vertical support member 213 as shown in FIG. 1, wherein an end of the vertical support member 213 that is provided with the support base 2131 acts as the support portion, and an insertion end 1221 that is configured to fit within the assembly sleeve 13a is arranged at an end of the vertical support member 213 away from the support base 2131.

Continuing to refer to FIGS. 4 to 6, each assembly sleeve 13a comprises: one assembly sleeve body 131 and two support strut retainers 133. The assembly sleeve body 131 has a sleeve opening 1311 at an end extending in a first direction Y (the first direction Y is perpendicular to the horizontal direction X in the embodiment of the present application), and the assembly sleeve body 131 has a sleeve side wall 130 and an insertion channel 1312 defined by the sleeve side wall 130. The sleeve opening 1311 is in communication with the insertion channel 1312, and the sleeve opening 1311 is configured for receiving the insertion end 1221 that is to be inserted into the insertion channel 1312, such that the insertion end 1221 is removably accommodated and retained within the insertion channel 1312. After the insertion end 1221 is inserted into the insertion channel 1312, the insertion end 1221 is disposed within and retained in the insertion channel 1312 of the assembly sleeve body 131 through the support strut retainer 133 that is defined within the sleeve side wall 130, allowing the frame support assembly 12 to support the side-section horizontal support member 11, such that the connection between the frame support assembly 12 and the side-section horizontal support member 11 can be implemented without any additional connecting components.

The number of the support strut retainers 133 is not specifically limited in the embodiment of the present application. For example, the number of the support strut retainers 133 may also be one, three or four, as long as the frame support assembly 12 and the assembly sleeve 13a can be stably connected.

When the insertion end 1221 of the frame support assembly 12 is arranged in the insertion channel 1312 of the assembly sleeve 13a, and when the assembly sleeve 13a is arranged in the sleeve insertion aperture 110, a portion of the frame support assembly 12 located outside of the sleeve insertion aperture 110 is sealed. In one aspect, the expression of “sealed” in the description of “a portion of the frame support assembly 12 located outside of the sleeve insertion aperture 110 is sealed” refers to: a portion of the frame support assembly 12 located outside of the sleeve insertion aperture 110 that has no opening exposed to the ambient air or extraneous effluent sources. Alternatively, the expression of “sealed” means that a portion of the frame support assembly 12 located outside the sleeve insertion aperture 110 is provided with a groove (not shown), but the groove is not in communication with the inside of the frame support assembly 12. In this way, water or other effluents are prevented from entering the inside of the frame support assembly 12 to cause corrosion, rusting, or other damage to the frame support assembly 12, thus the service life of the frame support assembly 12 can be enhanced, and user safety can be improved.

In an embodiment of the present application, although cross sections of the side-section horizontal support member 11 and the frame support assembly 12 are circular, embodiments of the present application do not specifically limit such cross-sectional shapes. For example, the cross sections of the side-section horizontal support member 11 and the frame support assembly 12 may also have oval shapes, square shapes, or any other desired cross-sectional profiles.

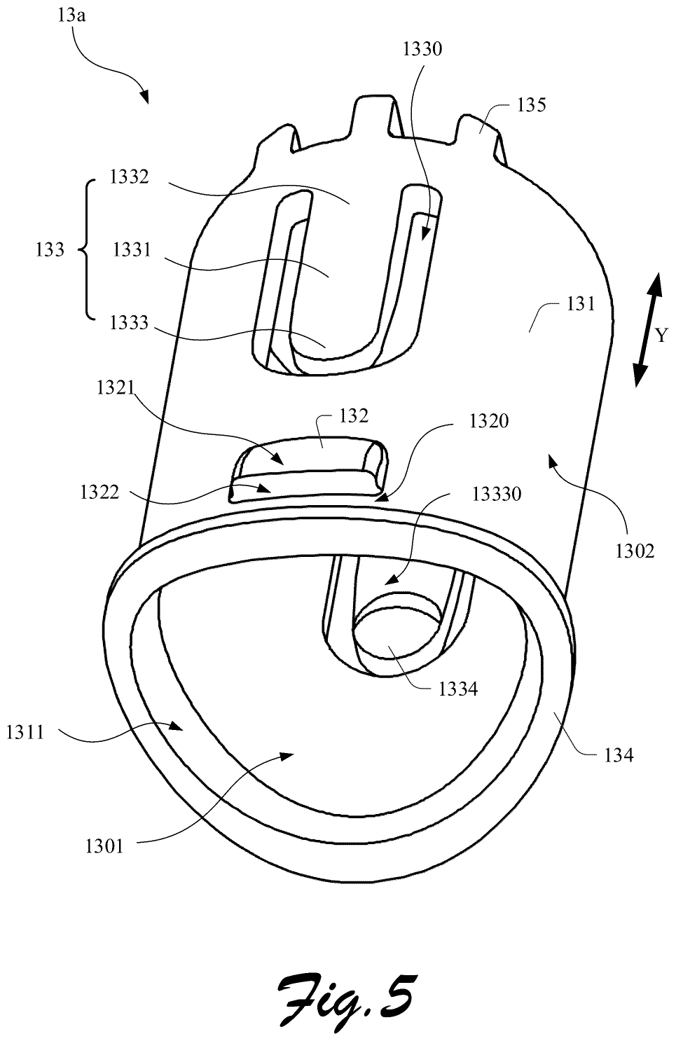

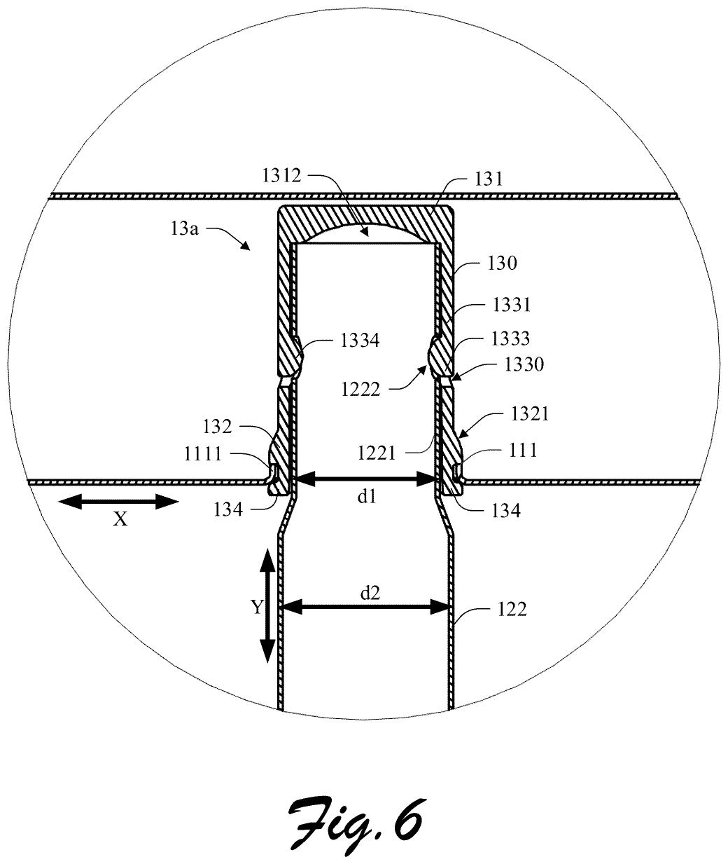

In a possible implementation, referring to FIGS. 5 and 6 in conjunction with FIG. 4, the support strut retainer 133 is arranged on the sleeve side wall 130. Specifically, the support strut retainer 133 comprises a flexible arm 1331, the sleeve side wall 130 is provided with a slot 1330, and the flexible arm 1331 is connected to an edge portion of the slot 1330 proximate the hinge end 1332. The slot 1330 is U-shaped and arranged around the flexible arm 1331 so as to provide a deformation space for the flexible arm 1331 to flex as the insertion end 1221 of the vertical support strut 122 is placed within the insertion channel 1312.

In an embodiment, the flexible arm 1331 comprises: a hinge end 1332 and a distal end 1333 opposite the hinge end 1332, wherein the hinge end 1332 is connected to the edges of the slot 1330 (in one implementation, the hinge end 1332 is integrally formed with the sleeve side wall 130 of the assembly sleeve body 131 at a position corresponding to the slot 1330), and the distal end 1333 is a free end, that is to say, the distal end 1333 is not connected to the edge of the slot 1330, such that the distal end 1333 can deviate toward the inside and the outside of the insertion channel 1312 under the action of the flexible arm 1331 so as to allow deformation.

In another aspect, an inner side wall 13330 of the distal end 1333 comprises a protrusion 1334, and a vertical support strut retention opening 1222 is correspondingly provided in a side wall of the insertion end 1221 of the vertical support strut 122. The protrusion 1334 is configured to snap-fit with the vertical support strut retention opening 1222, so as to limit the insertion end 1221 and the assembly sleeve 13a in the first direction Y, thereby retaining the insertion end 1221 in the insertion channel 1312 of the assembly sleeve 13a.

More specifically, a surface of the protrusion 1334 is rounded or has an arcuate profile, and such rounded/arcuate-shaped surface provides a guiding or registration function. In the process of arranging the insertion end 1221 in the assembly sleeve 13a, the insertion end 1221 enters, in the first direction Y, the insertion channel 1312 of the assembly sleeve body 131 through the sleeve opening 1311. When the insertion end 1221 is in contact with the protrusion 1334, under the guidance of the rounded/arcuate-shaped surface profile of the protrusion 1334, the flexible arm 1331 moves outward in a direction away from the insertion channel 1312. In this process, the insertion end 1221 continues to move toward the inside of the insertion channel 1312 in the first direction Y. When the insertion end 1221 moves to a position where the vertical support strut retention opening 1222 is opposite to the protrusion 1334, under the elastic action of the flexible arm 1331, the protrusion 1334 springs back and is urged into a concave-convex fit (i.e. snap-fit) with the vertical support strut retention opening 1222. In this case, the insertion end 1221 may be arranged in the assembly sleeve 13a to provide the mechanical connection between the frame support assembly 12 and the side-section horizontal support member 11. However, this does not mean that the insertion end 1221 is fixedly arranged in the assembly sleeve 13a in a snap-fitting manner. On the contrary, after the insertion end of the frame support assembly 12 is arranged in the assembly sleeve 13a, the protrusion 1334 can help prevent pool collapse caused by the insertion end 1221 unexpectedly sliding out from the assembly sleeve 13a due to shaking or other movement of the pool (such as when the pool is in use). When a user needs to detach the frame support assembly 12, the protrusion 1334 can be detached from the vertical support strut retention opening 1222 by slightly pulling the frame support assembly 12, thereby allowing detachment of the insertion end 1221 from the assembly sleeve 13a. Through the structure described above, the frame support assembly 12 and the side-section horizontal support member 11 may be connected or detached conveniently and quickly.

Put another way, when the frame support assembly 12 is connected to the side-section horizontal support member 11, a mechanical connection can be implemented by inserting the insertion end 1221 into the insertion channel 1312 through the sleeve opening 1311 of the assembly sleeve body 131 in the first insertion direction Y, without additional actions. Thus, connection of the frame support assembly 12 is convenient and fast. Also, the overall structure of the assembly sleeve 13a is substantially disposed within the sleeve insertion aperture 110 of the side-section horizontal support member 11. With the sealing features provided by the assembly sleeve 13a, including a flange 134, water or other effluents do not enter the frame support assembly 12 from a connection position between the assembly sleeve 13a and the insertion end 1221, such that a highly water-resistant result can be achieved.

In one embodiment, a positioning member is provided on an outer surface 1302 of the sleeve side wall 130 of the assembly sleeve body 131 to fix the assembly sleeve 13a in the sleeve insertion aperture 110.

In a possible implementation, continuing to refer to FIGS. 5 and 6 in combination with FIG. 4, the positioning member comprises two sleeve retention lugs 132, and the two sleeve retention lugs 132 are each arranged oppositely in a radial direction of the assembly sleeve 13a and are located on the outer surface 1302 of the sleeve side wall 130 of the assembly sleeve body 131. The number of sleeve retention lugs 132 is not specifically limited in the embodiment of the present application. Exemplarily, three, four or more sleeve retention lugs 132 may also be arranged.

Illustratively, each of the two sleeve retention lugs 132 is close to the sleeve opening 1311 in the first direction Y. Each of the two sleeve retention lugs 132 is configured to abut against an edge 111 of the sleeve insertion aperture 110 so as to fix the assembly sleeve 13a in the sleeve insertion aperture 110.

More specifically, each of the two sleeve retention lugs 132 comprises a guide surface 1321 and a bottom surface 1322. The bottom surface 1322 faces the sleeve opening 1311 in the first direction Y, and the bottom surface 1322 is configured to abut against the edge 111 of the sleeve insertion aperture 110. The guide surface 1321 extends away from the sleeve opening 1311 in the first direction Y.

In a possible implementation, referring to FIG. 6, the guide surface 1321 is a cambered surface.

In another possible implementation, the guide surface 1321 is an inclined surface which inclines toward the assembly sleeve body 131 in the horizontal direction X (not shown in FIG. 6) as the guide surface 1321 is traversed in a Y direction proximate the sleeve opening 1311 end toward an end of the assembly sleeve 13a proximate the reinforcing ribs 135.

In the process of arranging the assembly sleeve 13a in the sleeve insertion aperture 110, the assembly sleeve 13a is inserted into the sleeve insertion aperture 110 in the first direction Y, the guide surface 1321 is first in contact with the edge 111 and then continues to move toward the inside of the sleeve insertion aperture 110 in the first direction Y until the edge 111 crosses the bottom surface 1322, and at this point, affixing the assembly sleeve 13a within the sleeve insertion aperture 110 is completed.

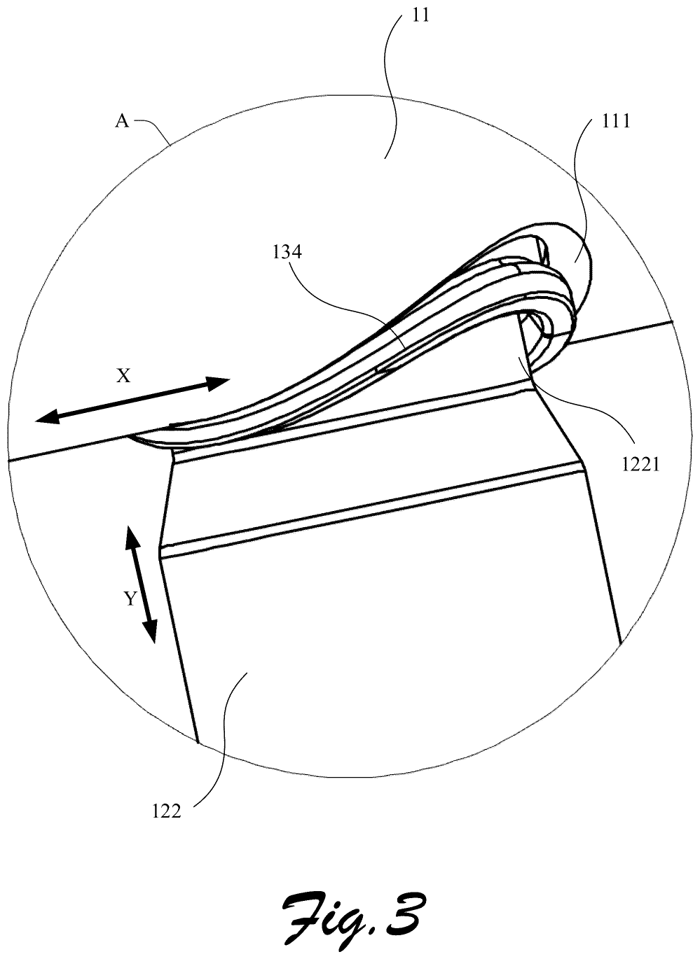

Continuing to refer to FIG. 5, in another possible implementation, a flange 134 is provided at a position of the outer surface 1302 of the sleeve side wall 130 close to the sleeve opening 1311 in the first direction Y. Referring to FIG. 3, the shape of the flange 134 matches the shape of the edge 111 of the sleeve insertion aperture 110 so as to close gaps between the sleeve insertion aperture 110 and the assembly sleeve 13a.

Referring to FIGS. 5 and 6, the flange 134 extends toward the outside of the insertion channel 1312 along the outer surface 1302 of the sleeve side wall 130. In the first direction Y, the flange 134 is spaced from the sleeve retention lug 132 to form a sleeve retention channel 1320. The sleeve retention channel 1320 is configured to snap-fit with the edge 111 of the sleeve insertion aperture 110, so as to limit the assembly sleeve 13a and the side-section horizontal support member 11 in the first direction Y, further improving the retention effect of the assembly sleeve 13a within the side-section horizontal support member 11.

In a possible implementation, the outer wall of the side-section horizontal support member 11 is bent in a position corresponding to the sleeve insertion aperture 110 toward the inside of the side-section horizontal support member 11 to form a sleeve retention lip 1111. The sleeve retention lip 1111 is configured to snap-fit with the sleeve retention channel 1320. The size of the sleeve retention lip 1111 in the first direction Y approximates the size of the sleeve retention channel 1320 in the first direction Y, so as to further improve the retention effect of the assembly sleeve 13a within the side-section horizontal support member 11.

It should be noted that in embodiments of the present application, the side-section horizontal support member 11 is a tubular component, and the length of the assembly sleeve 13a in the first direction Y is approximately the same (or slightly less) as an internal diameter of the side-section horizontal support member 11. When the assembly sleeve 13a is fixed in the sleeve insertion aperture 110, a portion of the assembly sleeve 13a except for the flange 134 is located inside the side-section horizontal support member 11. That is to say, in an embodiment of the present application, the connection between the insertion end 1221 and the assembly sleeve 13a is located inside of the side-section horizontal support member 11, and the portion of the insertion end 1221 located outside of the side-section horizontal support member 11 is not provided with a through hole, so that water entry into the frame support assembly 12 to cause rusting and/or corrosion of the frame support assembly 12 can be effectively prevented, the service life of the frame support assembly 12 can be enhanced, and user safety can be improved.

In additional embodiments, referring to FIG. 5, reinforcing ribs 135 are provided at an end of the assembly sleeve body 131 opposite from the sleeve opening 1311 in the first direction Y. In one aspect, the reinforcing ribs 135 may increase the structural strength of the assembly sleeve body 131.

In further embodiments, referring to FIG. 6, an outer diameter d1 of the insertion end 1221 is less than an outer diameter d2 of a remaining portion of the vertical support strut 122. In one aspect, the insertion end 1221 may be formed by swaging an end of the vertical support strut 122 to reduce an outside diameter thereof from the diameter d2 to the smaller diameter d1.

Embodiments of the present application do not specifically limit the cross-sectional shape of the assembly sleeve body 131 perpendicular to the first direction Y. For example, in the embodiment of the present application, the cross-sectional shape of the assembly sleeve body 131 is circular, and the sleeve insertion aperture 110 is also correspondingly circular. The assembly sleeve 13a may be circular or oval to match a shape of the sleeve insertion aperture 110. However, such shape is not limited thereto. The assembly sleeve body 131 and the sleeve insertion aperture 110 may also be oval, square, or may utilize other shapes as desired.

### Embodiment II

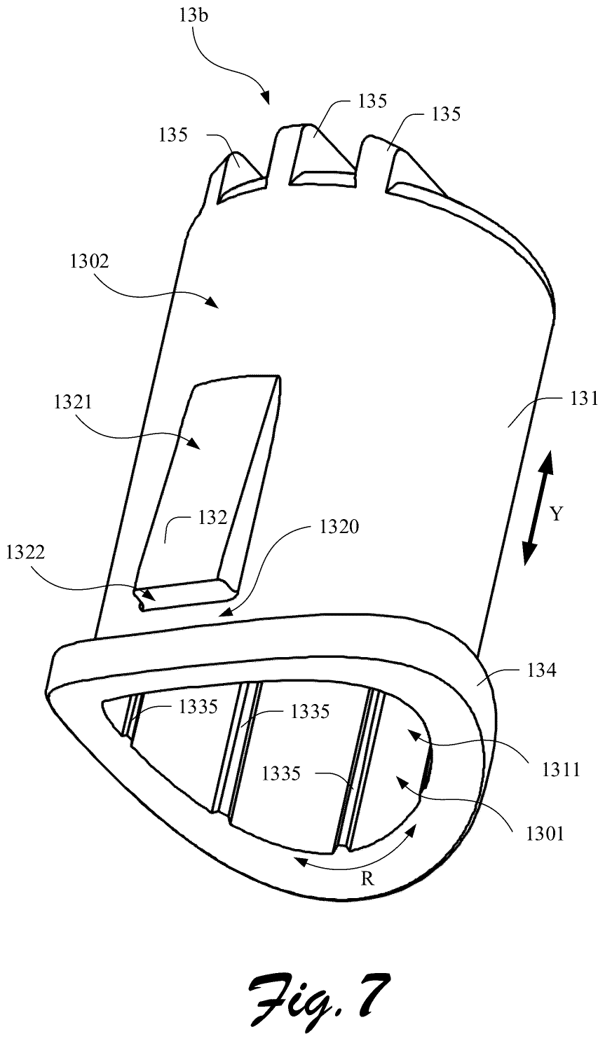

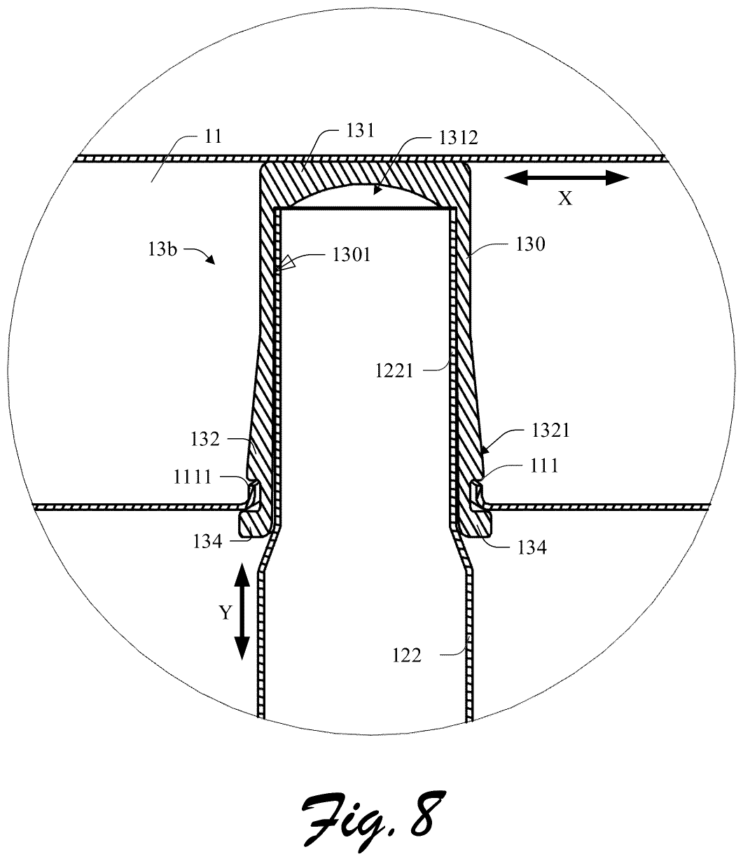

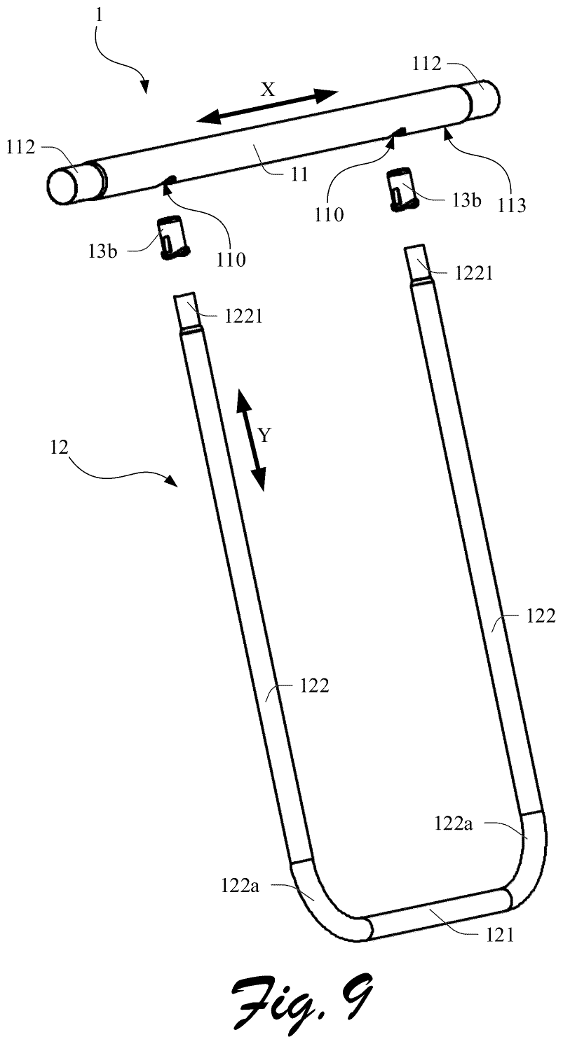

Referring to FIGS. 7 to 9, a support assembly 1 according to an embodiment of the present application comprises: a side-section horizontal support member 11, a frame support assembly 12 and assembly sleeves 13b. The side-section horizontal support member 11 and the frame support assembly 12 in the embodiment of the present application are similar to the side-section horizontal support member 11 and the frame support assembly 12 described in Embodiment I, and therefore will not be repeated.

Compared with Embodiment I, a difference between the support assembly 1 of embodiment II lies in that a retention of the insertion end 1221 of the vertical support strut 122 within the assembly sleeve 13b is provided by a plurality of protruding friction-fit ribs 1335, the plurality of friction-fit ribs 1335 being arranged at intervals on an inner surface 1301 of the sleeve side wall 130 of the assembly sleeve body 131 in a circumferential direction R of the assembly sleeve body 131. Each protruding rib of the plurality of protruding friction-fit ribs 1335 extends in a first direction Y. The plurality of friction-fit ribs 1335 are configured to provide an interference-based friction fit with the insertion end 1221. Correspondingly, the insertion end 1221 is not provided with a through-hole to prevent water or other effluents from entering the inside of the frame support assembly 12 to cause the rusting and/or corrosion of the frame support assembly 12. Accordingly, the service life of the frame support assembly 12 can be enhanced, and user safety can be improved.

Accordingly, in Embodiment II of the present application, the insertion end 1221 may not be provided with a through hole or vertical support strut retention opening 1222, thereby providing improved water resistance of the connection between the vertical support strut 122 and the side-section horizontal support member 11.

Embodiments of the present application do not specifically limit the number of the friction-fit ribs 1335, as long as the insertion end 1221 can be firmly arranged in the assembly sleeve 13b.

During mounting, the insertion end 1221 is inserted into the insertion channel 1312 from the sleeve opening 1311 in the first direction Y. After the insertion end 1221 is inserted into the insertion channel 1312, the plurality of protruding ribs 1335 are in interference/friction fit with the insertion end 1221 to retain the insertion end 1221 in the insertion channel 1312. In this implementation, the connection between the frame support assembly 12 and the side horizontal support member 11 is simple, convenient and fast.

Referring to FIG. 7, compared with Embodiment I, in Embodiment II, a guide surface 1321 of a sleeve retention lug 132 includes an inclined surface inclining toward the assembly sleeve body 131 in a horizontal direction X.

In another possible implementation, the guide surface 1321 of the sleeve retention lug 132 may also be a cambered surface (as shown in FIG. 5).

Another embodiment of the present invention provides a kit of components identified above that, when assembled, form the pool frame 21 and/or the frame pool 2 as shown and described herein. Any logical order of assembly may be undertaken within the spirit of the present embodiments to assemble the pool frame 21 and/or the frame pool 2, and steps may be reordered where necessary for convenience of assembly. Kits of components of the present embodiments present certain advantages. For example, a kit of components may be manufactured and compactly packaged for shipping, distribution, and sale to end users, thus providing a retail product that is an easily manageable size for consumers, shippers, and retailers alike compared to a fully assembled pool frame 21 and/or frame pool 2.

Although the present embodiments have been illustrated and described with reference to some preferred implementations, those of ordinary skill in the art should understand that the above contents are further detailed descriptions for the present application in conjunction with specific embodiments, and it cannot be assumed that the specific implementations of the present application are limited to these descriptions. Those skilled in the art can make various changes in form and details, including several simple deductions or substitutions, without departing from the spirit and scope of the presented embodiments.

What is claimed is:

1. A support assembly, comprising:
a side-section horizontal support member, one or more sleeve insertion apertures defined within a bottom side of an outer wall of the side-section horizontal support member;
a frame support assembly having one or more insertion ends;
one or more assembly sleeves respectively installed in the one or more sleeve insertion apertures, the one or more assembly sleeves each comprising:
an assembly sleeve body comprising a sleeve side wall and an insertion channel defined within the assembly sleeve body, the insertion channel configured to accommodate one of the one or more insertion ends; and
one or more support strut retainers arranged on the sleeve side wall, each of the one or more support strut retainers being configured to accept and retain one of the one or more insertion ends in the one or more assembly sleeves.

2. The support assembly of claim 1, wherein the assembly sleeve body comprises:
one or more sleeve retention lugs arranged on an outer surface of the sleeve side wall; and
a flange extending along the outer surface of the sleeve side wall toward the outside of the insertion channel, the flange being spaced from the one or more sleeve retention lugs to define a sleeve retention channel.

3. The support assembly of claim 2, wherein the outer wall of the side-section horizontal support member is formed into a shape corresponding to the sleeve insertion aperture toward the inside of the side-section horizontal support member to form a sleeve retention lip, and the sleeve retention lip is arranged in the sleeve retention channel to retain the assembly sleeve body in the sleeve insertion aperture.

4. The support assembly of claim 1, wherein:
the frame support assembly further comprises a retention opening disposed in a side wall of the insertion end; and
each of the one or more support strut retainers is arranged in a respective slot defined within the sleeve side wall of the one or more assembly sleeves, each of the one or more support strut retainers further comprising:
a flexible arm including a hinge end and a distal end, the hinge end connected to an edge of the slot abutting the support strut retainer; and
a protrusion defined within an interior side of the flexible arm at the distal end and configured to engage within the retention opening with a snap fit to retain a vertical support strut of the frame support assembly within the assembly sleeve.

5. The support assembly of claim 1, wherein the support strut retainer comprises a plurality of protruding ribs arranged on an inner surface of the sleeve side wall at intervals in a circumferential direction of the assembly sleeve body.

6. The support assembly of claim 1, wherein a cross section of the assembly sleeve body is circular or oval.

7. The support assembly of claim 1, wherein the frame support assembly is U-shaped.

8. The support assembly of claim 1, wherein an outer diameter of the insertion end is less than an outer diameter of a remaining portion of the frame support assembly.

9. A frame pool, comprising:
a liner; and
a frame assembly for supporting the liner, the frame assembly comprising:
two arcuate sections symmetrically arranged, each arcuate section comprising a plurality of arc-section horizontal support members, a plurality of vertical support members and a plurality of T-joints, every two adjacent arc-section horizontal support members connected to one of the vertical support members through one of the T-joints; and
two straight sections respectively arranged between the two arcuate sections, each straight section including at least one support assembly, each at least one support assembly including a side-section horizontal support member coupled to a frame support assembly through at least one assembly sleeve;
wherein each side-section horizontal support member is coupled at each end thereof to an end of one of the two arcuate sections at interceding T-joints, each interceding T-joint further coupled to a vertical support member, whereby the coupled arcuate sections and straight sections form a closed frame to support the liner.

10. The frame pool of claim 9, wherein:
each of the side-section horizontal support members has defined in a bottom side therein at least one sleeve insertion aperture; and
each of the assembly sleeves is respectively installed in a respective sleeve insertion aperture, the assembly sleeves each comprising:
an assembly sleeve body comprising a sleeve side wall and an insertion channel defined within the assembly sleeve body, the insertion channel configured to accommodate an insertion end of the frame support assembly of one of the at least one support assembly; and
one or more support strut retainers arranged on the sleeve side wall, each of the one or more support strut retainers being configured to accept and retain the insertion end in the assembly sleeve.

11. The frame pool of claim 10, wherein an outer wall of each side-section horizontal support member is formed into a shape corresponding to the sleeve insertion apertures toward the inside of each of the side-section horizontal support members to form a sleeve retention lip, and the sleeve retention lip is arranged in each corresponding sleeve retention channel to retain the respective assembly sleeve body when inserted into the respective sleeve insertion aperture.

12. The frame pool of claim 11, wherein:
the frame support assembly comprises a retention opening disposed in a side wall of the insertion end; and
each of the one or more support strut retainers is arranged in a respective slot defined within the sleeve side wall of the assembly sleeve, each of the one or more support strut retainers further comprising:
a flexible arm including a hinge end and a distal end, the hinge end being connected to an edge of the slot abutting the support strut retainer; and
a protrusion defined within an interior side of the flexible arm at the distal end and configured to engage within the retention opening with a snap fit to retain a vertical support strut of the frame support assembly within the assembly sleeve.

13. The frame pool of claim 11, wherein the support strut retainer comprises:
a plurality of protruding ribs arranged on an inner surface of the sleeve side wall at intervals in a circumferential direction of the assembly sleeve body.

14. The frame pool of claim 9, wherein the frame support assembly is U-shaped.

15. The frame pool of claim 9 further comprising:
a plurality of band guides respectively affixed to the liner between pairs of the vertical support members of the frame assembly; and
a reinforcing band that passes through the plurality of band guides and over the vertical support members and is tightened to secure and retain a position of each of the vertical support members and provide support for the liner.

16. A frame pool kit comprising:
a pool liner; and
a support assembly, comprising:
a side-section horizontal support member, one or more sleeve insertion apertures defined within a bottom side of an outer wall of the side-section horizontal support member;
a frame support assembly having one or more insertion ends;
a plurality of assembly sleeves configured to be respectively installed in the sleeve insertion apertures, the assembly sleeves each comprising:
an assembly sleeve body comprising a sleeve side wall and an insertion channel defined within the assembly sleeve body, the insertion channel configured to accommodate the insertion end; and
one or more support strut retainers arranged on the sleeve side wall, each of the one or more support strut retainers being configured to accept and retain the insertion end in the assembly sleeve.

17. The frame pool kit of claim 16, wherein the assembly sleeve body comprises:
one or more sleeve retention lugs arranged on an outer surface of the sleeve side wall; and
a flange extending along the outer surface of the sleeve side wall toward the outside of the insertion channel, the flange being spaced from the one or more sleeve retention lugs to define a sleeve retention channel.

18. The frame pool kit of claim 17, wherein the outer wall of the side-section horizontal support member is formed into a shape corresponding to the sleeve insertion aperture toward the inside of the side-section horizontal support member to form a sleeve retention lip, and the sleeve retention lip is configured to be arranged in the sleeve retention channel to retain the assembly sleeve body in the sleeve insertion aperture when the assembly sleeve body is inserted therein.

19. The frame pool kit of claim 16, wherein:
the frame support assembly comprises a retention opening disposed in a side wall of the insertion end; and
each of the one or more support strut retainers is arranged in a respective slot defined within the sleeve side wall of the assembly sleeve, each of the one or more support strut retainers further comprising:
a flexible arm including a hinge end and a distal end, the hinge end connected to an edge of the slot abutting the support strut retainer; and
a protrusion defined within an interior side of the flexible arm at the distal end and configured to engage within the retention opening with a snap fit so as to retain a vertical support strut of the frame support assembly within the assembly sleeve.

20. The frame pool kit of claim 16, wherein the support strut retainer comprises a plurality of protruding ribs arranged on an inner surface of the sleeve side wall at intervals in a circumferential direction of the assembly sleeve body.
